(19) United States
(12) Patent Application Publication
(10) Pub. No.: US 2016/0002874 A1
(43) Pub. Date: Jan. 7, 2016

(54) CONNECTION BETWEEN A FOUNDATION PILE OF A STRUCTURE AND AN IN PARTICULAR TUBULAR TRANSITION PIECE, AND METHOD FOR PRODUCING SAME

(71) Applicant: Klaus SCHULTES, Aurich (DE)

(72) Inventor: Klaus SCHULTES, Aurich (DE)

(21) Appl. No.: 14/770,865

(22) PCT Filed: Feb. 24, 2014
(86) PCT No.: PCT/EP2014/000475

§ 371 Date: Aug. 27, 2015

(30) Foreign Application Priority Data
Feb. 28, 2013 (EP) 13001017.6

(51) Int. Cl. E02D 5/52; E02D 5/54; F03D 11/04; E02D 27/50; E02D 27/52; E02D 27/42; E02D 5/50; E02D 27/12

(52) U.S. Cl. CPC E02D 5/526; E02D 5/50; E02D 5/54; E02D 27/12; E02D 27/50; E02D 27/52; E02D 27/425; F03D 11/045

(57) ABSTRACT

The invention relates to a connection between a foundation pile of a construction, in particular of an onshore or offshore construction, for example an onshore or offshore wind energy plant, having an in particular tubular transition piece, wherein the foundation pile and the transition piece are fitted one over the other or plugged one into the other with an intermediate space in between, and the intermediate space is at least partially filled with a mortar or concrete which has high strength after hardening, and to a method for producing same.

### TECHNICAL FIELD

The present invention relates to a connection between a foundation pile of a structure, in particular an onshore or offshore structure, such as, for example, an onshore or offshore wind turbine, and an in particular tubular transition piece. In what are known as grouted connections, the part having a transition function is also referred to as a transition piece. The transition piece can take the form of a pin or sleeve, for example.

### BACKGROUND

The prior art discloses, for example, a connection between a monopile and a transition piece of a wind turbine in the form of a grouted connection. This involves tube-in-tube plug connections in which steel cylinders are threaded one over the other. High-strength mortar is cast into the interspace.

In quite general terms, the grouting operation entails two usually tubular components being connected to one another by a special concrete or mortar (grout). For this purpose, the grout compound is introduced into a substantially annular gap (interspace), which is sealed at the bottom, and then cures. During the curing process, the components must not move substantially relative to one another, if at all, since the grout compound has an initially considerably reduced load-bearing capacity in the transition state between fresh and cured and must cure at rest.

When bringing together the components (before grouting), they are usually roughly centered by what are known as guide cleats and held at a minimum distance apart. However, these guide cleats cannot be used to prevent any movement of the components relative to one another. The reasons for this are as follows:
1. There must remain sufficient clearance between the components in order to be able to bring them together at all;
2. There should be no direct contact between relatively rigid metal parts in the components since this can lead to local load peaks.

Such a relative movement occurs perforce as it were if a plurality of supports (foundation piles/foundation tubes) are intended to support a common structure and one or more of the supports is/are exposed to the sea swell. What is known as a tripile foundation structure can be mentioned as an example. In what are known as monopiles (a foundation pile (ramming tube) and a transition piece placed thereon)), this problem arises in principle also as a result of inertia forces or else as a result of direct wave loading of the transition piece.

The grouting operation can therefore be carried out offshore only with a relatively low sea swell. These weather restrictions can considerably prolong the cost-intensive offshore work.

### SUMMARY

The object on which the present invention is based is therefore to protect the connection of the type mentioned at the outset from damage during curing of the high-strength concrete or mortar.

According to the invention, this object is achieved by a connection between a foundation pile of a structure, in particular an onshore or offshore structure, such as, for example, an onshore or offshore wind turbine, and an in particular tubular transition piece, in which the foundation pile and the transition piece are fitted one over the other or plugged one inside the other with an interspace therebetween and the interspace is at least partially filled with a concrete or mortar which has a high strength after curing, characterized in that, at least during curing, there are arranged in the interspace a first group of preferably at least three double wedges which are arranged against one another and which are arranged to run around at a distance from one another, and a second group, arranged axially offset with respect to the first group, of preferably at least three double wedges which are in each case arranged against one another and which are arranged to run around at a distance from one another, in order to suppress or inhibit a relative movement between the foundation pile and the transition piece, in particular a tilting and/or horizontal translational movement of the foundation pile. Here, the foundation pile can be designed to be tubular or cylindrical, for example. The transition piece can likewise be designed to be tubular or cylindrical, for example. The interspace is typically annular. The double wedges typically comprise an upper and a lower wedge. Instead of an axial offset between the first group and the second group, this may also be referred to as a height offset.

The double wedges of a respective group are advantageously arranged equidistantly over the circumference. The double wedges can be designed to be different within a group, but also between the groups.

The double wedges typically serve not to take up the intrinsic weight of the actual structure, such as, for example, of a support cross and/or of a tower, etc. Rather, they are intended to take up clamping forces which would otherwise manifest themselves in deformation. The aforementioned intrinsic weight is typically taken up by a supporting device with or without the possibility of height adjustment.

The double wedges of one group are advantageously arranged at a large vertical distance from the double wedges of the other group.

Furthermore, the object is achieved by a method for producing a connection between a foundation pile of a structure, in particular an onshore or offshore structure, such as, for example, an onshore or offshore wind turbine, and an in particular tubular transition piece, in particular according to one of the preceding claims, wherein the method comprises: fitting the foundation pile and the transition piece one over the other or plugging them one inside the other with an interspace therebetween, at least partially filling the interspace with a concrete or mortar which has a high strength after curing, and leaving the concrete or mortar to cure, characterized by, before leaving the concrete or mortar to cure, arranging in the interspace a first group of preferably at least three double wedges which are arranged in each case against one another and run round at a distance from one another, and a second group, arranged axially offset with respect to the first group, of preferably at least three double wedges which are in each case arranged against one another and run around at a distance from one another, in order to suppress or inhibit a relative movement between the foundation pile and the transition piece, in particular a tilting and/or horizontal translational movement of the foundation pile.

Provision can be made in the connection for at least one of the double wedges of the first group and/or at least one of the double wedges of the second group to be designed to be self-locking. For this purpose, the “wedge angles” of the wedges of a respective double wedge must be chosen correspondingly (to be correspondingly small). For example, the first group of double wedges and/or the second group of double wedges can be arranged before introducing the concrete or mortar.

According to a particular embodiment of the invention, at least one of the wedges of a double wedge of the first group and/or at least one of the wedges of a double wedge of the second group is/are premounted. To be more precise, at least one of the wedges of a double wedge of the first group and/or at least one of the wedges of a double wedge of the second group can be mounted on the foundation pile or the transition piece.

At least one of the wedges of a double wedge of the first group and/or at least one of the wedges of a double wedge of the second group is/are advantageously configured to be height-displaceable during mounting. As a result, the wedges can be pushed together during mounting.

In a further particular embodiment of the invention, at least one double wedge of the first group and/or at least one double wedge of the second group is/are provided with a device for setting a defined distance between the two wedges of the respective double wedge.

At least one of the wedges of a double wedge of the first group and/or at least one of the wedges of a double wedge of the second group is/are advantageously fixed in its/their height position by means of a magnet.

At least one of the wedges of a double wedge of the first group and/or at least one of the wedges of a double wedge of the second group is/are advantageously arranged outside the region containing the concrete or mortar. As a result, the wedge/wedges can be removed again after the concrete or mortar has cured.

Provision can furthermore be made for at least one of the wedges of a double wedge of the first group and/or at least one of the wedges of a double wedge of the second group to be arranged inside the region containing the concrete or mortar.

Provision can further be made, during curing, for a supporting device to be arranged to support the transition piece on the foundation pile.

The supporting device is also advantageously designed to adjust the transition piece in height.

According to a further preferred embodiment, the stiffness of at least one of the wedges of a double wedge of the first group and/or the stiffness of at least one of the wedges of a double wedge of the second group is/are adapted to the stiffness of the concrete or mortar after curing. This is particularly advantageous when the wedges are intended to remain in the actual concrete or mortar region, since stress peaks are avoided by virtue of comparable load-bearing and elastic properties. To ensure that the wedges do not themselves lead to uncontrolled stress peaks, it is advantageous in principle for the wedges, in a suitable number with a correspondingly dimensioned bearing face, to be embodied as double wedges which are arranged against one another. For example, by using a suitable material or preferably a combination of materials (for example steel and plastic), the stiffness of the wedges can be adapted to the stiffness of the concrete or mortar.

In the method, at least one of the wedges of a double wedge of the first group and/or least one of the wedges of a double wedge of the second group is/are advantageously is/are arranged by premounting on the foundation pile and/or on the transition piece.

At least one of the double wedges is expediently arranged by the wedges of the double wedge being pushed together relative to one another.

At least one of the double wedges is advantageously removed again after the concrete or mortar has cured.

Provision can additionally be made for at least one of the double wedges to be arranged in the region of the subsequently filled concrete or mortar.

Finally, provision can also be made for at least one of the double wedges to be arranged outside of the subsequently filled concrete or mortar.

The invention is based on the surprising finding that the play still present after the transition piece has been aligned is suppressed by the special wedge construction (double wedges). As a result, the concrete or mortar is protected from damage by a to and fro movement for example due to the sea swell during curing.

In the case of monopiles, for example, the double wedges can additionally also serve to align the system.

By virtue of the invention, the weather window for such a grouting operation can be considerably extended and the grouted connection can be protected from damage during curing.

According to a particular embodiment, it is also possible, by pushing together the wedges of respective double wedges in a controlled manner, for the components to be better centered relative to one another or, in the case of monopiles, also to completely align them.

The connection and the method can be used, at least in particular embodiments, both for monopiles and for “multi”-piles, tripods, jackets, etc.

### BRIEF DESCRIPTION OF THE DRAWINGS

Further features and advantages of the invention will become apparent from the appended claims and the following description in which a number of exemplary embodiments are explained in detail with reference to the schematic drawings, in which

FIG. 1 shows a sectional view of a connection according to a particular embodiment of the present invention;

FIG. 2 shows a detail view of FIG. 1;

FIG. 3 shows a double wedge according to a particular embodiment of the invention in a view like that of FIG. 2;

FIG. 4 shows a double wedge with a fixing of the lower wedge according to a particular embodiment of the invention in a view like that of FIG. 2; and

FIG. 5 shows a further particular embodiment of a double wedge in a view like that of FIG. 2.

### DETAILED DESCRIPTION

The description given below shows foundation piles in the form of cylindrical tubes into which a transition piece is plugged from above, said transition piece being formed at its lower end as a pin. However, there is in principle also the other possibility, namely that a transition piece which is formed at its lower end as a sleeve is fitted over a foundation pile which is formed, for example, as a cylindrical tube. In the case of the last-mentioned exemplary embodiments, which are not shown and described here however, the double wedges can also be used analogously.

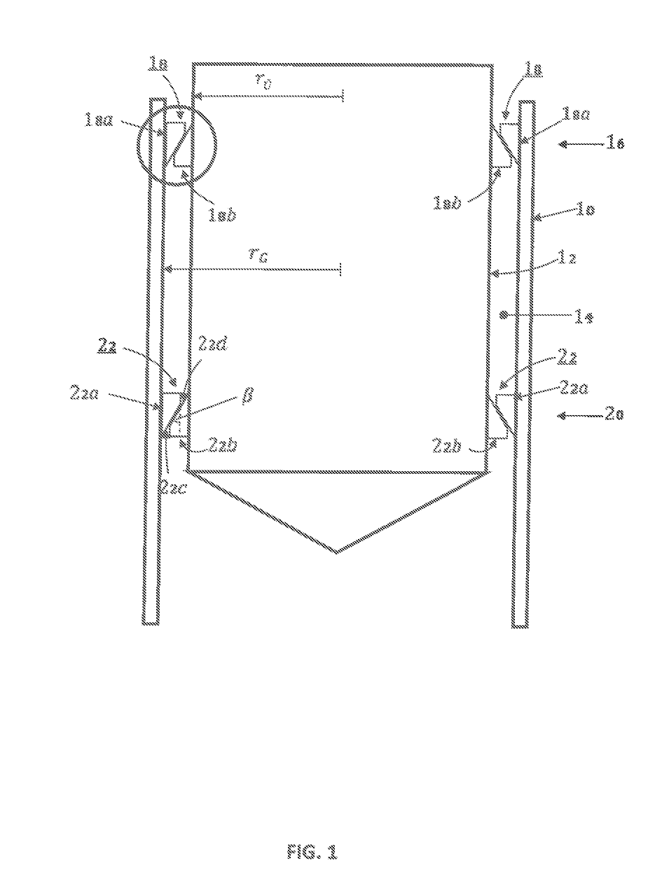

Moreover, the faces of the double wedges which lie on one another (contact faces) can also be oriented oppositely to the embodiments shown in FIGS. 1 to 5, relative to the vertical.

FIG. 1 shows a connection between a cylindrical foundation pile 10 of a foundation structure (not shown) of an offshore wind turbine (not shown) and a substantially tubular transition piece 12 which is formed as a pin, in which the transition piece 12 is plugged into the foundation pile 10 with an interspace 14 therebetween, according to a particular embodiment of the present invention. In an upper axial plane 16 there are arranged a plurality of double wedges 18 (of which only two are shown or visible) which preferably run around equidistantly in the annular interspace 14, and in a lower axial plane 20 there are likewise arranged a plurality of double wedges 22 (of which only two are shown or visible) which preferably run around equidistantly in the annular interspace 14. The double wedges 18 and 22 are configured and arranged in such a way that they make it possible, for example, to centrally align the transition piece 12 in the foundation pile 10 and also to suppress or inhibit a relative movement between the foundation pile 10 and the transition piece 12.

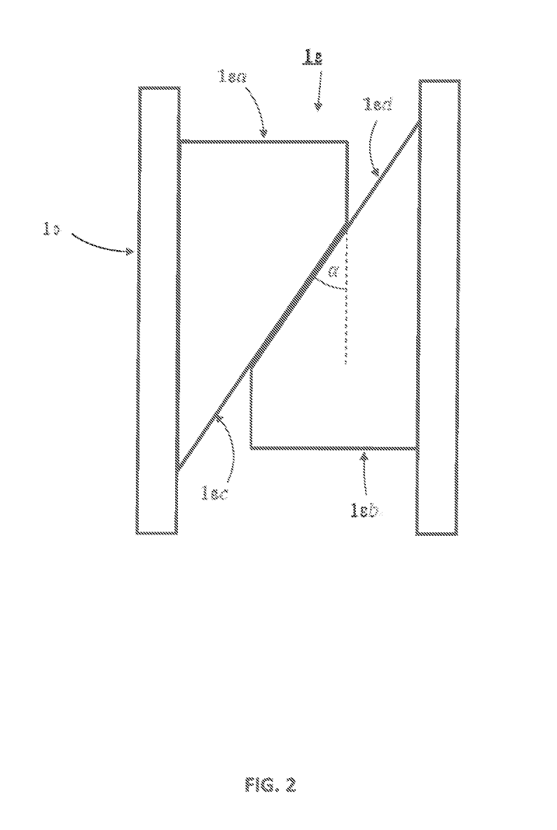

Each of the double wedges 18 and 22 has two wedges 18a and 18b, 22a and 22b which are arranged against one another. Depending on the size of the wedge angle a which is formed by the contact faces 18c and 18d, which are in contact with one another, of the wedges 18a and 18b and which is also formed, in some circumstances, by the contact faces 22c and 22d of the 22a and 22b, the wedges 18a and 18a and 22a and 22b can theoretically slide on one another (sliding friction) or else not (static friction). The last-mentioned case is also referred to as self-locking. In the exemplary embodiment shown in FIGS. 1 and 2, the wedge angle β of the lower double wedges 22 is identical to the wedge angle a. However, this does not have to be the case.

In the exemplary embodiment shown in FIGS. 1 and 2, the contact faces 18d and 22d of the respective inner wedge 18b and 22b extend obliquely outward from top to bottom and the contact faces 18c and 22c of the outer wedges 18a and 22a extend correspondingly. However, in another exemplary embodiment, they could extend in mirror-image fashion with respect to the vertical.

As is furthermore particularly evident from FIG. 2, the maximum dimensions of the wedges 18a, 18b, 22a and 22b in the radial direction are smaller than the difference between the radius r_{G} of the foundation pile and the radius r_{Ü} of the transition piece.

Furthermore, the wedges 18a and 18b and the wedges 22a and 22b can be premounted or else installed only during the mounting operation.

FIGS. 1 and 2 do not show that the transition piece 12 is held at a predetermined or predeterminable height via, for example, a supporting device. By virtue of the supporting device, the wedges 18a, 18b, 22a and 22b do not have to bear the intrinsic weight of the further structure, such as, for example, tower, situated above.

FIGS. 1 and 2 also show no grout in the interspace 14 or a part thereof. However, it should be mentioned at this point that all or else only a part of the lower wedges 22a and 22b and/or all of the upper wedges 18a and 18b can be situated inside or outside a region containing grout.

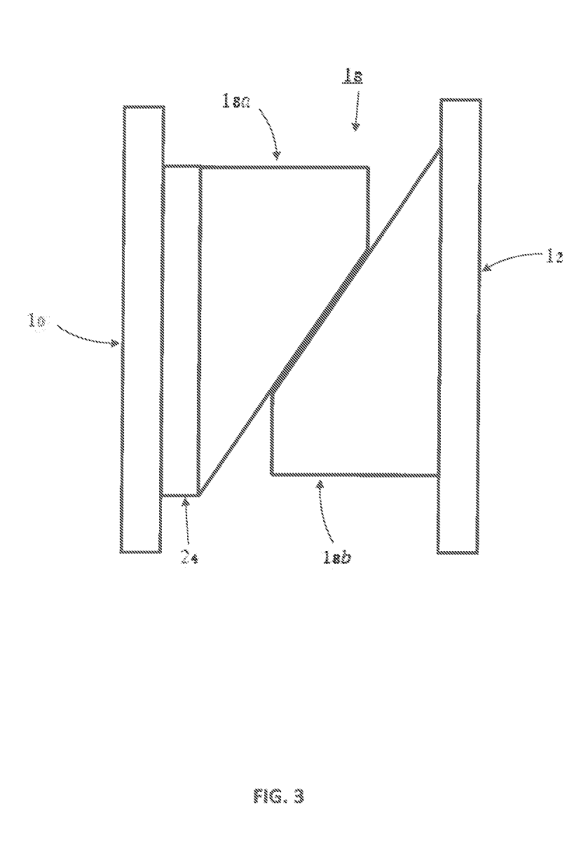

In the embodiment of double wedges illustrated in FIG. 3, the outer wedge 18a made of a combination of materials, namely steel and plastic, has been adapted in order to adapt the stiffness thereof to that of the grout material. Said wedge 18b has a layer 24 of plastic toward the foundation pile 10, while the rest of the wedge is made of steel.

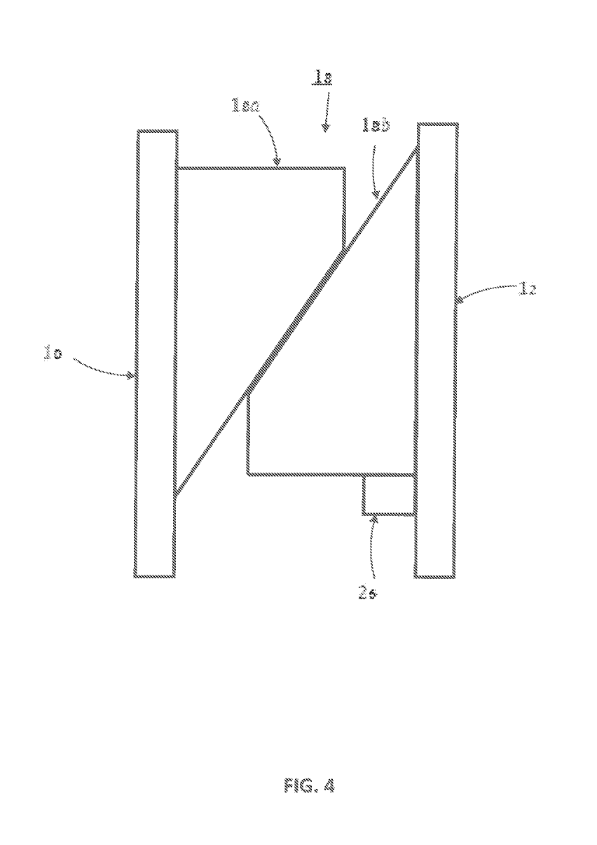

In the further embodiment illustrated in FIG. 4, the lower wedge 18b, i.e. the one situated toward the transition piece 12 in the present example, is fixed in its height position at its lower side by a magnet 26 which can be clamped onto the outer side of the transition piece 12. The magnet 26 can also be used to fix guides for wedges. In principle, the magnet or magnets can be advantageously used during or after the final alignment of the wedges, in particular if the wedges can only be premounted with difficulty.

If the wedges can be moved in a vertically controlled manner, the foundation pile 10 and the transition piece can be better aligned with one another by a controlled pushing-together of one or both wedges of a double wedge or, in the case of monopiles, can also be completely aligned.

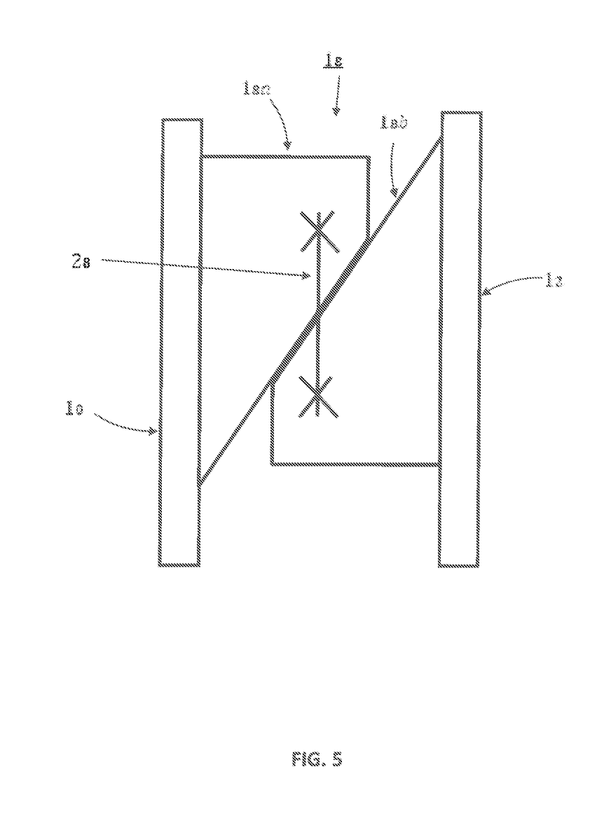

Finally, FIG. 5 shows an embodiment in which a double wedge 18 is assigned a device for setting a defined distance between the two wedges 18a and 18b in the vertical direction. This device is illustrated only schematically and provided with the reference number 28.

In the embodiments shown above, the double wedges can be installed in the region of the upper and lower grout wedge. Depending on the particular embodiment, the double wedges can be removed again after the grout has cured or can remain at the installation site.

According to a particular embodiment of the present invention, a method for producing the above-described connections, but also other connections according to the invention, comprises:

plugging the transition piece 12 into the foundation pile 10 with said interspace 14 therebetween, at least partially filling the interspace 14 with a concrete (grout) which has a high strength after curing, arranging in the interspace 14 a first group of a plurality of double wedges, such as, for example, double wedges 18 or 22, which are arranged against one another and run around at a distance from one another, and a second group of a plurality of double wedges, such as, for example, double wedges 22 or 18, which run around at a distance from one another, in order to suppress or inhibit a relative movement between the foundation pile 10 and the transition piece 12, in particular a tilting and/or horizontal translational movement of the foundation pile 10, and leaving the concrete to cure.

In order to mount the double wedges or wedges “from below”, a typically present lower opening in the transition piece 12 could be used.

The connection and the method allow support of a grouted connection or a grouted fixing.

The features of the invention disclosed in the present description, in the drawings and in the claims may be essential both individually and in any desired combinations for implementing the invention in its various embodiments.

### LIST OF REFERENCE SIGNS

10 Foundation pile
12 Transition piece
14 Interspace
16 Upper axial plane
18 Double wedges
18a, 18b Wedges
18c, 18d Contact faces
20 Lower axial plane
22 Double wedges
22a, 22b Wedges
22c, 22d Contact faces
24 Layer
26 Magnet
28 Device for setting a defined distance
a, β Wedge angle
r_{G} Radius of the foundation pile
r_{Ü} Radius of the transition piece

1. Connection between a foundation pile of a structure and a tubular transition piece, in which the foundation pile and the transition piece are fitted one over the other or plugged one inside the other with an interspace therebetween and the interspace is at least partially filled with a concrete or mortar which has a high strength after curing,
wherein,
at least during curing, there are arranged in the interspace a first group of double wedges which are arranged against one another and which are arranged to run around at a distance from one another, and a second group, arranged axially offset with respect to the first group, of double wedges which are in each case arranged against one another and which are arranged to run around at a distance from one another, in order to suppress or inhibit a relative movement between the foundation pile and the transition piece.

2. Connection according to claim 1, wherein at least one of the double wedges of the first group and/or at least one of the double wedges of the second group is/are designed to be self-locking.

3. Connection according to claim 1, wherein at least one of the wedges of the double wedge of the first group and/or at least one of the wedges of the double wedge of the second group is/are premounted.

4. Connection according to claim 1, wherein at least one of the wedges of the double wedge of the first group and/or at least one of the wedges of the double wedge of the second group is/are configured to be height-displaceable during mounting.

5. Connection according to claim 1, wherein at least one double wedge of the first group and/or at least one double wedge of the second group is/are provided with a device for setting a defined distance between the two wedges of the respective double wedge.

6. Connection according to claim 1, wherein at least one of the wedges of the double wedge of the first group and/or at least one of the wedges of the double wedge of the second group is/are fixed in its/their height position by means of a magnet.

7. Connection according to claim 1, wherein at least one of the wedges of the double wedge of the first group and/or at least one of the wedges of the double wedge of the second group is/are arranged outside the region containing the concrete or mortar.

8. Connection according to claim 1, wherein at least one of the wedges of the double wedge of the first group and/or at least one of the wedges of the double wedge of the second group is/are arranged inside the region containing the concrete or mortar.

9. Connection according to claim 1, wherein, during curing, a supporting device is arranged to support the transition piece on the foundation pile.

10. Connection according to claim 8, wherein the supporting device is also designed to adjust the transition piece in height.

11. Connection according to claim 1, wherein the stiffness of at least one of the wedges of the double wedge of the first group and/or the stiffness of at least one of the wedges of the double wedge of the second group is/are adapted to the stiffness of the concrete or mortar after curing.

12. Method for producing a connection between a foundation pile of a structure and a tubular transition piece, wherein the method comprises:
fitting the foundation pile and the transition piece one over the other or plugging them one inside the other with an interspace therebetween, at least partially filling the interspace with a concrete or mortar which has a high strength after curing, and
leaving the concrete or mortar to cure,
wherein, before leaving the concrete or mortar to cure, arranging in the interspace a first group of double wedges which are in each case arranged against one another and run around at distance from one another, and a second group, arranged axially offset with respect to the first group, of double wedges which are in each case arranged against one another and run around at a distance from one another, in order to suppress or inhibit a relative movement between the foundation pile and the transition piece.

13. Method according to claim 12, wherein at least one of the wedges of the double wedge of the first group and/or at least one of the wedges of the double wedge of the second group is/are arranged by premounting on the foundation pile and/or on the transition piece.

14. Method according to claim 11, wherein at least one of the double wedges is arranged by the wedges of the double wedge being pushed together relative to one another.

15. Method according to claim 12, wherein at least one of the double wedges is removed again after the concrete or mortar has cured.

16. Method according to claim 12, wherein at least one of the double wedges is arranged in the region of the subsequently filled concrete or mortar.

17. Method according to claim 12, wherein at least one of the double wedges is arranged outside of the subsequently filled concrete or mortar.

18. Connection according to claim 1, wherein both the first group of double wedges and the second group of double wedges comprise at least three of the double wedges.

19. Method according to claim 12, wherein both the first group of double wedges and the second group of double wedges comprise at least three of the double wedges.

20. Connection according to claim 1, wherein the relative movement to be suppressed or inhibited is a tilting and/or horizontal translational movement of the foundation pile.

21. Method according to claim 12, wherein the relative movement to be suppressed or inhibited is a tilting and/or horizontal translational movement of the foundation pile.
